(19) United States
(12) Patent Application Publication
(10) Pub. No.: US 2015/0317034 A1
(43) Pub. Date: Nov. 5, 2015

(54) WATER-IMMUNE FTIR TOUCH SCREEN

(71) Applicant: ELO TOUCH SOLUTIONS, INC., Milpitas, CA (US)

(72) Inventors: Joel C. KENT, Fremont, CA (US); David Hecht, San Diego, CA (US)

(73) Assignee: ELO TOUCH SOLUTIONS, INC., Milpitas, CA (US)

(21) Appl. No.: 14/265,998

(22) Filed: Apr. 30, 2014

(51) Int. Cl. G06F 3/042; G06F 1/16

(52) U.S. Cl. CPC G06F 3/0421; G06F 1/16; G06F 2203/04109; G06F 2203/04107; G06F 2203/04104

(57) ABSTRACT

Disclosed herein are systems and methods for a water-immune FTIR touchscreen. An optically clear adhesive with an index of refraction between that of water and human skin in the infrared wavelength range is placed below a touchscreen interface substrate. Light beams with a glancing angle greater than a critical glancing angle determined by the index of refraction of the optically clear adhesive do not totally internally reflect at the interface of the touchscreen interface substrate and the optically clear adhesive. Light beams with a glancing angle below the critical glancing angle totally internally reflect. A glancing angle that totally internally reflects at the substrate/optically clear adhesive interface will also totally internally reflect at an interface of the substrate and any water on the surface of the substrate, rendering the touchscreen immune to the effects of water.

### BACKGROUND

Frustrated Total Internal Reflection (FTIR) touchscreens rely on the total internal reflection of propagating light beams within a substrate to determine whether a touch event occurs. Near infrared light is commonly used in such FTIR touchscreens. Touch events occur when the propagating light beams are “frustrated” from totally internally reflecting, and therefore partially or completely exiting the substrate. This occurs when something replaces air as the medium at a surface of the substrate, such as a finger.

Other media, such as water, can result in false positives with FTIR touchscreens. Water drops on the surface of the substrate can cause light beams (that would otherwise totally internally reflect at an air/substrate interface) to refract and “frustrate” the total internal reflection of the light beams where a touch event has not occurred. This causes FTIR touchscreens to be unduly susceptible to water, limiting their applicability in outdoor situations and other environments that require more robustness.

### BRIEF DESCRIPTION OF THE DRAWINGS

The accompanying drawings are incorporated herein and form a part of the specification.

FIG. 1A illustrates the interaction of a light beam between materials of different indices of refraction according to an embodiment.

FIG. 1B illustrates the interaction of light beams with different angles of incidence between materials of different indices of refraction according to an embodiment.

FIG. 1C illustrates the interaction of light beams with different angles of incidence between materials of different indices of refraction according to an embodiment.

FIG. 2 illustrates a block diagram of a touchscreen according to an embodiment.

FIG. 3 illustrates a side view of a touchscreen display system according to an embodiment.

FIG. 4 illustrates a side view of an interaction of light beams with different touchscreen layers according to an embodiment.

FIG. 5 illustrates an exemplary process for creating a water-immune touchscreen according to an embodiment.

FIG. 6 illustrates an exemplary process for water-immune touchscreen touch detection according to an embodiment.

FIG. 7 illustrates an exemplary computer system that can be used to implement aspects of embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are apparatus, system, method, computer program product embodiments, and/or combinations and sub-combinations thereof, for a water-immune FTIR touchscreen. In an embodiment, a filter layer with an index of refraction between that of water and that of human skin in the infrared (IR) wavelength range is placed below a substrate that functions as the touchscreen surface, and through which light beams are propagated for FTIR functionality. In an embodiment, the filter layer is an optically clear adhesive with a desired index of refraction at IR wavelengths. Light beams with a glancing angle greater than a critical glancing angle, as determined by the index of refraction of the optically clear adhesive, do not totally internally reflect at the interface of the substrate that functions as the touchscreen surface and the optically clear adhesive. As a result, in an embodiment, only light beams with a glancing angle below the critical glancing angle will totally internally reflect. Since the optically clear adhesive has an index of refraction greater than that of water, light that is sufficiently parallel to substrate surfaces to totally internally reflect at the substrate/optically clear adhesive interface will also totally internally reflect at an interface of the substrate and any water on the surface of the substrate, rendering the touchscreen immune to the effects of water (such as spurious touch detections). Other features of embodiments of the water-immune touchscreen are described below.

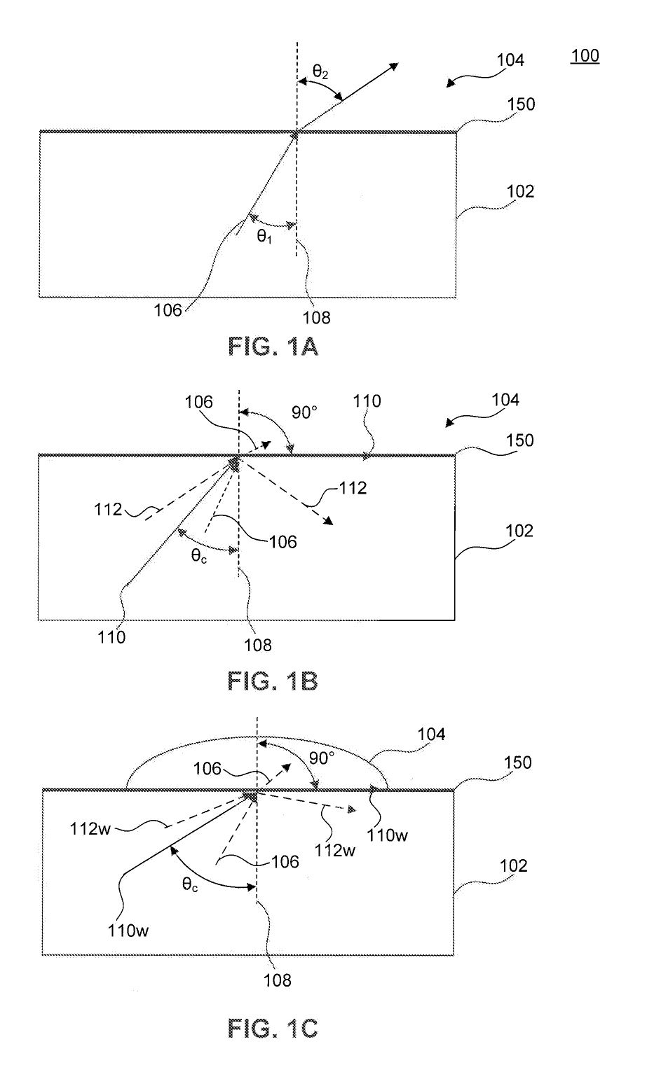

FIG. 1A illustrates the interaction of a light beam between materials of different indices of refraction according to an embodiment. Snell's Law is useful to describe the relationship between the angle of incidence (measured with respect to the surface normal 108) of a light beam 106 and the index of refraction of the media through which the light beam traverses. For example, in FIG. 1A the light beam 106 first traverses medium 102, for example glass, at a first angle of incidence θ₁. When the light beam 106 reaches boundary 150 between the medium 102 and the medium 104, for example air, the light beam 106 refracts because of the different indices of refraction of the two media. As a result, the angle of the light beam 106 after refraction at the boundary 150 is θ₂ with respect to the surface normal 108, such that θ₂ is greater than θ₁ with respect to the surface normal 108.

FIG. 1B illustrates the interaction of light beams of different angles of incidence between materials of different indices of refraction according to an embodiment. For purposes of simplicity of discussion, the differences between FIGS. 1A and 1B will be discussed. Light beam 110 has a different angle of incidence than that of light beam 106. In FIG. 1B, light beam 110 has an angle of incidence θ_{C}, otherwise referred to as the critical angle, or the largest angle with respect to the surface normal 108 that still refracts at the boundary 150. The critical angle θ_{C} may be computed using equation 1:

θ_{C}=arcsin(n₂/n₁). (1)

In equation 1, n₁ corresponds to the value of the index of refraction of the first medium that the light beam 110 enters, here medium 102, and n₂ corresponds to the value of the index of refraction of the second medium, here medium 104. Light beam 110 is a special case because, when refracting at the boundary 150, the light beam 110 does not enter the medium 104 but rather propagates along the boundary 150, as can be seen in FIG. 1B. In this example, the critical angle θ_{C} of light beam 110 is approximately 42° based on n₂ having a value of 1 and n₁ having a value of 1.5.

Light beam 112 has an angle of incidence with respect to the surface normal 108 that is greater than the critical angle θ_{C}. According to Snell's Law, since the index of refraction of the medium 104 is less than the index of refraction of the medium 102, the sine of the angle of refraction would be greater than one, which does not happen. Instead, the light beam 112 is totally reflected at the boundary 150, which is often referred to as “total internal reflection.” This can be seen in FIG. 1B as the light beam 112 does not exit medium 102 upon reaching the boundary 150, but rather totally reflects and remains within the medium 102.

FIG. 1C illustrates the interaction of light beams of different angles of incidence between materials of different indices of refraction when water is present on a surface according to an embodiment. The differences between FIG. 1C and FIGS. 1A and 1B will be discussed. In FIG. 1C, instead of the second medium 104 being air above the boundary 150, the second medium 104 is a drop of water above the boundary 150. Water has a different index of refraction than air—water's index of refraction is greater than air's index of refraction—and therefore the critical angle θ_{C} is different based on the result of equation 1. For example, FIG. 1C illustrates light beam 110w with an angle of incidence θ_{C} with respect to the surface normal 108 such that light beam 110w results in the largest angle of incidence that will still refract at the boundary 150. In this example, the critical angle θ_{C} of light beam 110w is approximately 62° based on n₂ having an approximate value of 1.33 and n₁ having a value of 1.5.

The light beam 112w is also depicted with a larger angle of incidence in FIG. 1C when compared to the light beam 112 in FIG. 1B. Light beam 112w totally internally reflects in FIG. 1C because its angle of incidence is greater than the critical angle θ_{C}. In comparing FIG. 1C to FIG. 1B, the presence of water at the boundary 150, instead of air, increases the value of the critical angle above which total internal reflection occurs. If light at angles of incidence with respect to the surface normal 108 that are less than the critical angle θ_{C} are eliminated, then the water 104 on the surface at the boundary 150 would not attenuate, or “frustrate,” infrared light beams introduced within the first medium 102, such as glass.

The angles of incidence discussed above in FIGS. 1A, 1B, and 1C are described with reference to the surface normal 108, since the light beams shown in the above figures originate from below the medium 102. In embodiments, light beams may be introduced into the medium 102 from a source to the side of the medium 102, so that the light propagates generally in a direction parallel to the boundary 150. In such embodiments, reference is made to the critical glancing angle, which herein refers to the angle that is the complement to the critical angle. The critical glancing angle θ_{CG} may be computed using equation 2:

θ_{CG}=90°−arcsin(n₂/n₁)=arcos(n₂/n₁). (2)

Although equation 2 is written in terms of degrees, those skilled in the relevant art(s) will recognize that the equation may be adjusted to be expressed in terms of radians or any other units of angular measure. The critical glancing angle θ_{CG} refers to the angle of introduction to the medium 102 with respect to the boundary 150, or the axis perpendicular to the surface normal 108. The critical glancing angle θ_{CG} describes the angles of introduction below which total internal reflection will occur, and the angles at and above which refraction will occur.

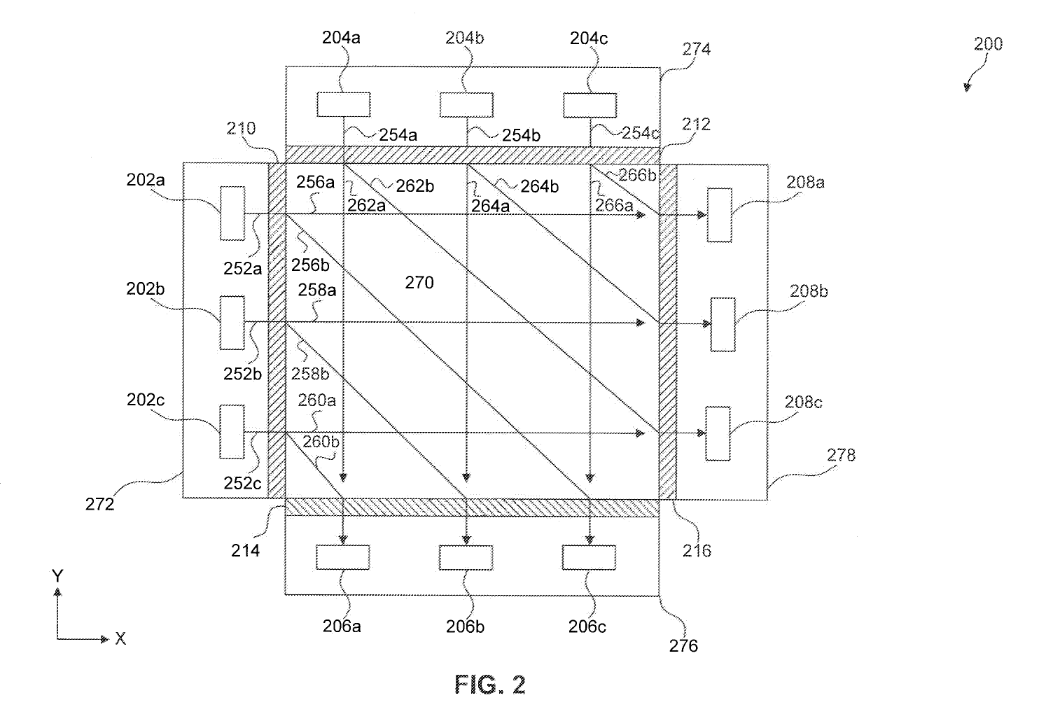

FIG. 2 illustrates a block diagram of a touchscreen 200 that introduces light beams from the sides of the propagating medium, providing an exemplary environment in which embodiments of the present disclosure may be applied. In an embodiment, touchscreen 200 may be an IR touchscreen utilizing FTIR touch detection. In a further embodiment, touchscreen 200 may be capable of detecting multiple touches at a time, such as the touchscreens discussed in U.S. Pat. No. 8,243,048, which is incorporated by reference herein in its entirety.

Touchscreen 200 may include a touch area 270, an outer edge 272 along the left vertical side (e.g., along a Y-axis), an outer edge 274 along the top horizontal side (e.g., along an X-axis), an outer edge 276 along a bottom horizontal side, and an outer edge 278 along a right vertical side of the touch area 270. Touchscreen 200 includes light sources 202a-202c that provide light beams 252a-252c, respectively, along the outer edge 272 as well as light sources 204a-204c that provide light beams 254a-254c, respectively, along the outer edge 274. The light sources 202a-202c and 204a-204c may be any from a variety of types of light sources, such as light emitting diodes (LEDs). In an embodiment, the light sources 202a-202c and 204a-204c provide light beams 252a-254c in the IR band. For purposes of discussion, a few light sources have been depicted in FIG. 2, although more or less may be used to produce light beams as will be recognized by those skilled in the relevant art(s).

Proximate to light sources 202a-202c is a beam splitter 210. Beam splitter 210 may be placed between the light sources 202a-202c and the touch area 270 to split the light beams 252a-252c into two or more light beams to traverse the touch area 270. Focusing now on light beam 252a for purposes of discussion, light beam 252a reaches beam splitter 210 and is split into two light beams, 256a and 256b. Beam splitter 210 may alternatively split the light beam 252a into more than two beams, as will be recognized by those skilled in the relevant art(s). Light beam 256a may continue propagation through the beam splitter 210 in the original direction, here along the X axis toward the outer edge 278. Light beam 256b, however, may be deflected by the beam splitter 210 and propagate in a direction at an angle with respect to the undeflected light beam 256a. In an embodiment, the light beam 256b may propagate at a 45° angle from the direction of propagation of the light beam 256a, although other angles are also possible. The deflected light beam 256b may propagate along the angled path toward a different outer edge, here outer edge 276. The beam splitter 210 may similarly affect the light beams 252b and 252c, as shown in FIG. 2. Although shown proximate to each light source, beam splitter 210 may alternatively be proximate to a subset of all of the light sources of the touchscreen 200.

In similar fashion, beam splitter 212 is situated proximate to the light sources 204a-204c, between the light sources 204a-204c and the touch area 270. The beam splitter 212 splits the light beams 254a-254c into two or more light beams to traverse the touch area 270. Focusing on light beam 254a for purposes of discussion, light beam 254a reaches the beam splitter 212 and is split into two light beams, 262a and 262b. Light beam 262a may continue propagation through the beam splitter 212 in the original direction, here along the Y axis toward the outer edge 276. Light beam 262b may propagate in a direction at an angle with respect to the undeflected light beam 262a. In an embodiment, the light beam 262b may propagate at a 45° angle from the direction of propagation of the light beam 262a, although other angles are also possible. The deflected light beam 262b may propagate along the angled path toward a different outer edge, here outer edge 278. The beam splitter 212 may similarly affect the light beams 254b and 254c, as shown in FIG. 2.

In an embodiment, while outer edges 272 and 274 include light sources, outer edges 276 and 278 include light detectors 206a-206c and 208a-208c, respectively. As shown in FIG. 2, light detectors 206a-206c are located along the outer edge 276, in a position opposite the light sources 204a-204c to form respective light paths between sources and detectors. In an embodiment, the light detectors 206a-206c may be phototransistors. In similar manner, light detectors 208a-208c are located along the outer edge 278, in a position opposite the light sources 202a-202c to form respective light paths between the sources and detectors. For simplicity of discussion, a few light detectors have been depicted in FIG. 2, although more or less may be used to detect light beams as will be recognized by those skilled in the relevant art(s).

The beam splitter 214 is situated proximate to the light detectors 206a-206c, or any subset thereof, between the light detectors 206a-206c and the touch area 270. The beam splitter 214 receives the light beams transmitted from the light sources 204a-204c without deflection and from the light sources 202a-202c after deflection. Focusing on light detector 206a, the beam splitter 214 receives the undeflected light beam 262a emitted from the light source 204a on the outer edge 274 opposite the light detector 206a. The beam splitter 214 also receive the deflected light beam 260b from light source 202c after deflection by the beam splitter 210. The beam splitter 214 redirects the deflected light beam 260b to travel in a direction parallel to the light beam 262a. In an embodiment, the light beam 260b and the light beam 262a are thereby combined at the beam splitter 214 for detection at the light detector 206a. The beam splitter 214 may similarly affect the other light beams shown traversing the touch area 270 for reaching the light detectors 206b and 206c.

In a similar fashion, beam splitter 216 is situated proximate to the light detectors 208a-208c, or any subset thereof, between the light detectors 208a-208c and the touch area 270. The beam splitter 216 receives the light beams transmitted from the light sources 202a-202c without deflection and from the light sources 204a-204c after deflection. Focusing on light detector 208a, the beam splitter 216 receives the undeflected light beam 256a emitted from the light source 202a on the outer edge 272 opposite the light detector 208a. The beam splitter 216 also receive the deflected light beam 266b from light source 204c after deflection by the beam splitter 212. The beam splitter 216 redirects the deflected light beam 266b to travel in a direction parallel to the light beam 256a. In an embodiment, the light beam 266b and the light beam 256a are thereby combined at the beam splitter 216 for detection at the light detector 208a. The beam splitter 216 may similarly affect the other light beams shown traversing the touch area 270 for reaching the light detectors 208b and 208c.

The beam splitters 210, 212, 214, and 216 may split (or combine) the light beams using one or more of diffraction, refraction and reflection. Although each splitter is shown as one continuous splitter in FIG. 2, each of the beam splitters may be split up and placed at the appropriate locations by the respective light sources and light detectors. These functions may alternatively be accomplished by a lens mounted to each of the light sources and light detectors. Use of the beam splitters 210 and 212 to provide the deflected beams to diagonally traverse the touch area 270 may eliminate the need, expense and design complications of providing additional sources and detectors to generate and detect diagonal beams. Alternatively, one or more of the beam splitters 210-216 may be eliminated and replaced by dedicated diagonal-beam elements on the sides where beam splitters are removed. In yet another alternative, one or more of the light sources 202a-202c and 204a-204c may be provided with a fan-like spread of emission directions and one or more of the light detectors 206a-206c and 208a-208c may be provided with a fan-like spread of reception directions. In some embodiments, one or more of the light sources 202a-202c and 204a-204c are sequentially activated while in other embodiments multiple light sources from among 202a-202c and/or 204a-204c utilize coding schemes to substantially simultaneously provide light beams with improved signal to noise ratio.

In an embodiment, as the light beams traverse the touch area 270 in the propagating medium (e.g., by propagating in a substrate such as a glass substrate) in horizontal, vertical and/or diagonal directions, only light beams that are introduced at less than the critical glancing angle θ_{CG} will totally internally reflect, while those with larger angles will be filtered out by an optically clear adhesive situated below the propagating medium. The glancing angle is in a plane perpendicular to the plan view shown in FIG. 2. For example, the light beams of FIG. 2 may each include many total internal reflections while propagating in the medium. According to the principles of FTIR touch designs, when human skin, such as that associated with a finger, touches the surface of the propagating medium, the area where the finger touches has a different index of refraction than the air around it. This difference in the index of refraction changes the critical glancing angle θ_{CG} at the surface/finger interface such that at least some of the propagating light beams with glancing angles above the critical glancing angle θ_{CG} at the location of the touch no longer totally internally reflect, but rather refract out of the propagating medium. In other words, those light beams that refract out at the location of the touch are “frustrated” from total internal reflection. This translates into a reduction of the intensity of the light beams detected at one or more of the light detectors of FIG. 2. A processor, discussed further below, receives the detected signals from the light detectors and utilizes the information to determine where on the screen the touch event (or events where there have been multiple touches at the same time) occurred.

While the above embodiments of FIG. 2 have been discussed with respect to splitting each generated light beams 252a-252c and 254a-254c into two respective light beams each for traversal across the touch area 270, the touchscreen 200 may be designed to split the generated light beams 252a-252c and 254a-254c into more than two light beams each, set at multiple angles across the touch area 270. In addition, one or more of the multiple light beams may be spread to a desired degree and one or more of the light detectors 206a-206c and 208a-208c modified accordingly to receive the spread beams. In such embodiments, there may be additional light detectors positioned to receive the additional split light beams, which may result in the ability to detect even more simultaneous (or substantially simultaneous) touches at a given time with sufficient certainty. Further, although FIG. 2 illustrates the detectors as located along one or more edges of the touchscreen 200, one or more detectors may be situated below the touch area 270 to detect scattered light to register touches while still remaining within the scope of the present disclosure, as will be recognized by those skilled in the relevant art(s).

Since the optically clear adhesive has an index of refraction greater than that of water, a glancing angle that totally internally reflects at the propagating medium/optically clear adhesive interface will also totally internally reflect at an interface of the substrate and any water on the surface of the propagating medium, rendering the touchscreen immune to the effects of water.

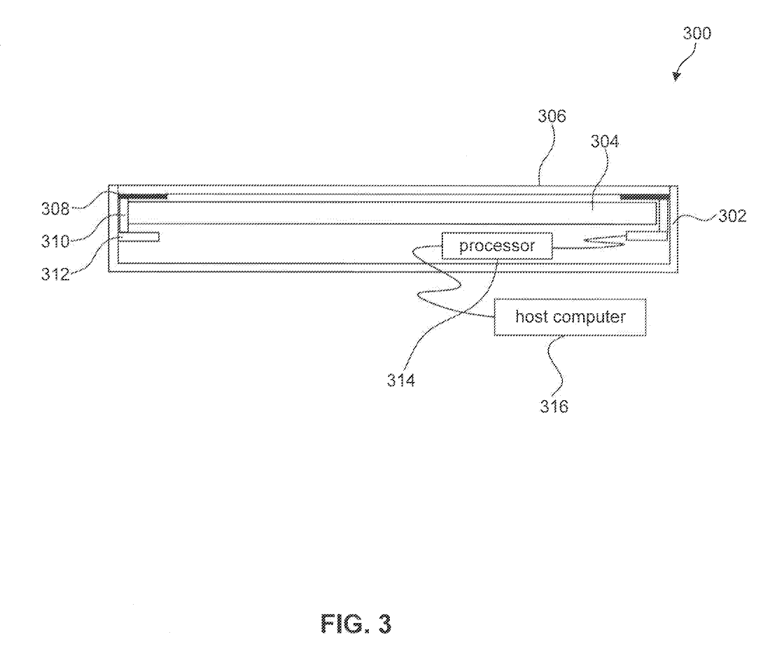

FIG. 3 illustrates a side view of a touchscreen display system 300 according to an embodiment. The touchscreen display system 300 may include at least a casing 302, a display 304, a touchscreen 306, a border 308, an optical coupler 310, an IR frame 312 (e.g., a set of connected printed circuit boards in a picture frame geometry containing IR light sources and IR detectors), a processor 314 and a host computer 316.

The display 304 may be any kind of display designed to project an image and/or data to a viewer. In an embodiment, the display 304 may be a liquid crystal display (LCD). Alternatively, the display 304 may be a plasma, organic light-emitting diode (OLED) or cathode ray tube (CRT) display, to name just a few examples. In alternative embodiments, the display 304 need not be an emissive display but may rather be a reflective display such as an electrophoretic display, which improves readability of the display in bright sunlight environments.

The touchscreen 306 is placed above the display 304 to receive input from a user with respect to what is output on the display 304. In an embodiment, the touchscreen 306 may be the touchscreen 200, such as an IR touchscreen, discussed above with respect to FIG. 2. Alternatively, the touchscreen 306 may be physically and functionally integrated with the display 304. The border 308 is located along the edges of the touchscreen 306, and in an embodiment may be a coating that is sufficiently absorbing of visible light to appear black to the human eye, but is transparent to IR light (such as near IR).

The optical coupler 310 may be a waveguide to introduce the propagating light beams into the signal propagating layer of touchscreen 306, as well as forward the propagated light beams after traversing the touch area to one or more light detectors. In an embodiment, depending upon the side of the touchscreen display system 300, the IR frame 312 may include one or both of light sources and light detectors. In an embodiment, the light detectors on the IR frame 312 may be capable of grayscale signal detection. On a side where light is introduced to the touchscreen 306, the optical coupler 310 receives at least one light beam from at least one light source on IR frame 312. On a side where light is forwarded on from the touchscreen 306 after traversal, the optical coupler receives at least one light beam and couples it to at least one light detector on IR frame 312. Although the IR frame 312 is depicted in FIG. 3 as being below the touchscreen 306, in an alternative embodiment, the IR frame 312 may be positioned on one or more sides of the touchscreen 306.

The processor 314 may include one or more processing cores. Further, the processor 314 may be a collection of processors operating in cooperation for given computing tasks. In an embodiment, the processor 314 may utilize an ARM architecture, although other processor architectures, types, speeds and configurations are possible as will be appreciated by those skilled in the relevant art(s). The processor 314 may control operation of the display 304 and the touchscreen 306. Alternatively, there may be a separate processor dedicated to the control of each of the display 304 and the touchscreen 306. The output from the light detectors on the IR frame 312 may be input into the processor 314 for the implementation of one or more touch detection algorithms.

The touchscreen display system 300 may be coupled to the host computer 316. The host computer 316 may be a separate, standalone device to which the touchscreen display system 300 connects, or may be a system with which the touchscreen display system 300 is integrated at least within the same casing 302. In an embodiment, the processor 314 shares implementation of one or more touch detection algorithms with the host computer 316.

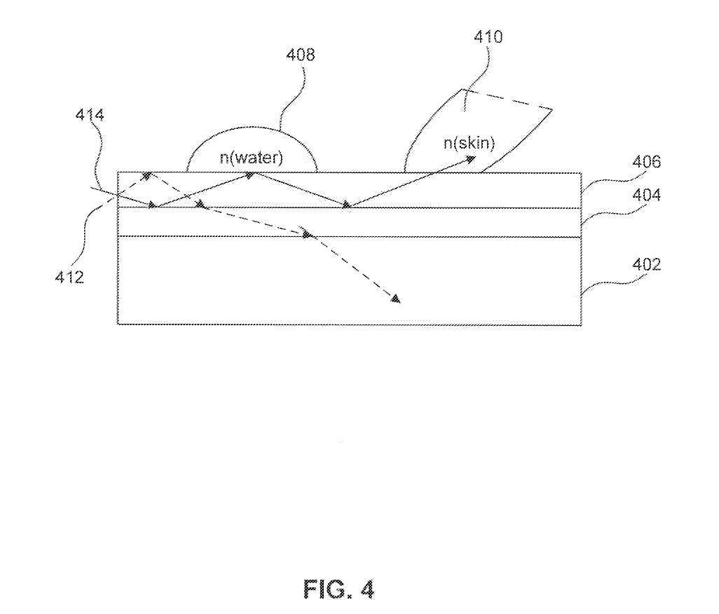

FIG. 4 illustrates a side view of different layers of a touchscreen and an interaction of light beams with those layers, according to an embodiment. In an embodiment, the combination of the different layers comprise the touchscreen 306 of FIG. 3 and/or the touch area 270 of the touchscreen 200 of FIG. 2.

The different layers of the touchscreen may include a lower substrate layer 402, a middle layer 404 and an upper substrate layer 406. In an embodiment, the lower and upper substrate layers 402 and 406, respectively, may be glass with an approximate index of refraction of 1.5 at IR wavelengths. In an embodiment, the upper substrate layer 406 may have a thickness between one millimeter and six millimeters; alternatively, the thickness may be less than one millimeter or more than six millimeters. When the upper substrate layer 406 has a smaller thickness, such as one millimeter or less, more total internal reflections will occur resulting in more opportunities for a finger to frustrate the total internal reflections, resulting in greater touch sensitivity. When the upper substrate layer 406 has a larger thickness, fewer total internal reflections will occur that may not be 100% efficient resulting in a slower rate of attenuation of the IR beams. This may enable larger touchscreen sizes with acceptable signal levels. In an embodiment, the thickness of the lower substrate 402 may also be less than one millimeter, between one and six millimeters, or greater than six millimeters. When the lower substrate 402 is thicker, it provides greater mechanical strength. When the lower substrate is thinner, it is more compact with less weight and may minimize parallax between a display image and the touch surface.

The middle layer 404 is a layer with an index of refraction different from that of the upper substrate layer 406. In an embodiment, the middle layer 404 may be an optically clear adhesive that bonds the upper and lower substrate layers 406/402. In an embodiment, the thickness of the middle layer 404 may be between 100 microns and one millimeter so as to accommodate potential manufacturing variations in flatness of the lower substrate layer 402 and the upper substrate layer 406, while avoiding unnecessary cost for optically clear adhesive. The thickness of the middle layer 404 may also be less than 100 microns or more than one millimeter. According to embodiments of the present disclosure, the optically clear adhesive layer 404 may have an index of refraction that is less than the index of refraction for human skin, such as that of a finger 410, and greater than the index of refraction of water 408, each shown touching a different portion of a surface of the upper substrate layer 406 in FIG. 4. In an embodiment, the optically clear adhesive layer 404 has an index of refraction of 1.4 at IR wavelengths. As a result, the critical glancing angle θ_{CG} of the interface between the upper substrate layer 406 and the optically clear adhesive layer 404 may be computed according to Equation 2:

θ_{CG}=arccos(1.4/1.5)=˜21°.

Any light beams that are introduced into the upper substrate layer 406 that have a critical glancing angle of 21° or higher will not totally internally reflect at the boundary of the upper substrate layer 406 and the optically clear adhesive layer 404. This is demonstrated by light beam 412 in FIG. 4 (dashed arrow line). As shown in FIG. 4, light beam 412 is introduced into the upper substrate layer 406, for example as discussed above with respect to touchscreen 306, at a glancing angle greater than 21°. As a result, when the light beam 412 reaches the interface between the optically clear adhesive layer 404 and the upper substrate layer 406, instead of totally internally reflecting, the light beam 412 refracts through the optically clear adhesive layer. As the light beam continues, because of its glancing angle, the light beam 412 also refracts into the lower substrate layer 402 since the index of refraction of the lower substrate layer 402 is greater than the index of refraction of the optically clear adhesive layer 404. The light beam 412 is thereafter either absorbed or otherwise conveyed away so that it does not return to the upper substrate layer 406. For example, the lower substrate layer 402 may be made from an IR absorbing material such as soda-lime glass, which contains IR absorbing iron impurities. Alternatively, the lower substrate layer 402 may be, or be a part of, a display device so that there are no air gaps between the touch surface and the display image. This configuration may reduce the loss of displayed image contrast from reflections of ambient light at air/solid interfaces, which may be of interest in applications involving direct sunlight exposure.

Light beam 414 (solid arrow line) provides an example of a light beam that is introduced into the upper substrate layer 406 at a glancing angle less than the critical glancing angle θ_{CG}, or 21° in this example. As a result, when the light beam 414 reaches the interface between the optically clear adhesive layer 404 and the upper substrate layer 406, the light beam 414 totally internally reflects and continues to propagate along a direction parallel to the interface between the two layers.

As shown in FIG. 4, a droplet of water 408 may be present on the surface of the upper substrate layer 406, with an approximate index of refraction of 1.33. According to Equation 2, the critical glancing angle θ_{CG} at the interface between the droplet of water 408 and the upper substrate layer 406 is computed as:

θ_{CG}=arccos(1.33/1.5)=˜30°.

Any light beams introduced into the upper substrate layer 406 at a glancing angle at or above 30° will not totally internally reflect but rather refract into the droplet of water 408. According to embodiments of the present disclosure, however, the optically clear adhesive layer 404 filters out any light beams that were introduced at a glancing angle above approximately 21°. Since any remaining light beams, such as light beam 414, would therefore be at most at a glancing angle of 21° and less than the critical glancing angle θ_{CG} for water of 30°, the light beam 414 also totally internally reflects at the interface of the droplet of water 408 and the upper substrate layer 406. In effect, therefore, the touchscreen of FIG. 4 and according to embodiments of the present disclosure is water-immune in that the light beams traversing the upper substrate layer 406 do not refract into water to cause a spurious touch detection.

FIG. 4 additionally shows a finger 410 touching the surface of the upper substrate layer 406 at a different location. The index of refraction for the finger 410 may be estimated to be at approximately 1.5 at IR wavelengths. See, e.g., Tsenova et al., “Refractive Index Measurement in Human Tissue Samplings,” Phys. Med. Biol. 51, 1479 (2006) (reporting index of refraction values for dehydrated human tissue samples at around 1.5 for IR wavelengths). Since the finger 410 and the upper substrate layer 406 have approximately the same index of refraction, the critical glancing angle θ_{CG} at the interface between the finger 410 and the upper substrate layer 406 is around 0°. Light beam 414, which would still totally internally reflect at the water/substrate interface would not totally internally reflect at the finger/substrate interface—total internal reflection at the finger 410/upper substrate layer 406 is frustrated since the light beam 414 would refract out of the upper substrate layer 406. In this manner, the touchscreen according to embodiments of the present disclosure will be immune to water at the interface with the upper substrate layer 406 but still be responsive to finger 410 touches. In FIG. 4, the droplet of water 408 and the finger 410 are illustrated as being located at separate regions of the surface of the upper substrate layer 406. However, the droplet of water 408 may cover a considerable area including the surface area around finger 410. Even in such situations, the droplet of water 408 would still be ignored and the finger 410 touching the surface would be detected. In an embodiment, the water droplet 408 may represent water that covers a majority or entirety of the active surface, such as the surface of the upper substrate layer 406, and embodiments of the present disclosure ignore the water and detect touches from one or more fingers. This level of immunity to water is not provided by other types of touchscreens, such as capacitive touchscreens.

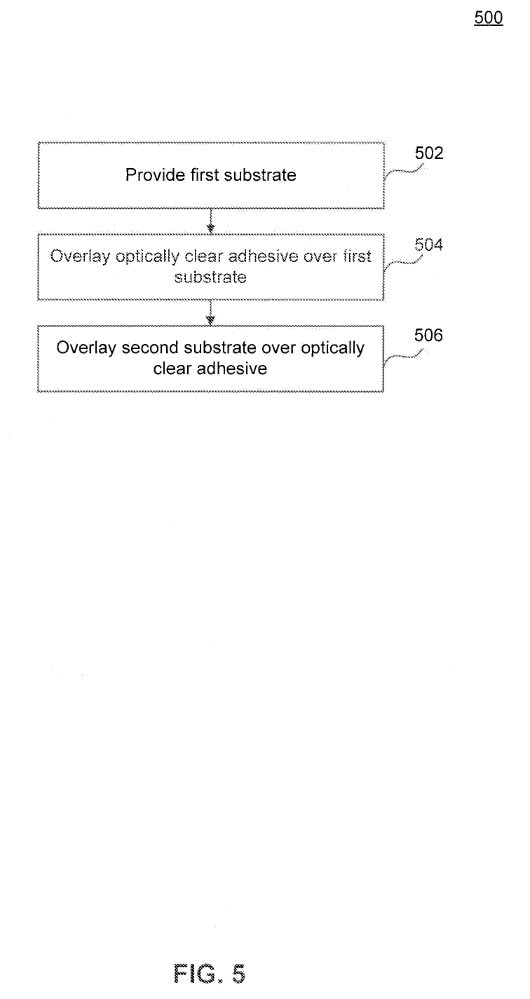

FIG. 5 illustrates an exemplary process 500 for creating a water-immune touchscreen according to an embodiment.

Process 500 begins at step 502, where a first substrate is provided. In an embodiment, such as discussed above with respect to FIG. 4, the first substrate may be a lower glass substrate or a flat panel display such as an electrophoretic display.

At step 504, an optically clear adhesive is overlaid above the first substrate. In an embodiment, the optically clear adhesive has an index of refraction that is greater than that of water, but less than that of human skin.

At step 506, a second substrate is overlaid above the optically clear adhesive. In an embodiment, the second substrate may be an upper glass substrate. In a further embodiment, the second substrate may have approximately the same index of refraction as the first substrate, such as within 5% of each other, which may be greater than the index of refraction of the optically clear adhesive, which serves to bond the two substrates together.

In an alternative embodiment, the first substrate may be omitted, leaving the second substrate with an optically clear adhesive bonded to the first substrate's lower surface, or the surface opposite the surface which a finger would touch.

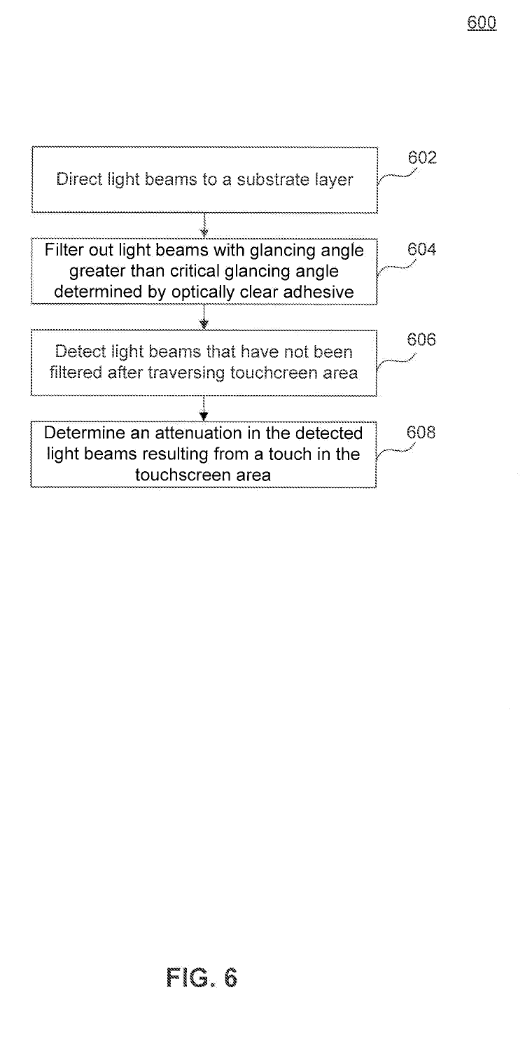

FIG. 6 illustrates an exemplary process 600 for water-immune touchscreen touch detection according to an embodiment. Process 600 utilizes a touchscreen, such as touchscreen 200 and touchscreen 306 and as demonstrated in FIG. 4, that has been created according to embodiments of the present disclosure, such as discussed above with respect to FIG. 5.

At step 602, light beams are directed into a substrate layer at one or more glancing angles that can propagate the light to an opposite end where one or more detectors are situated. In an embodiment, the substrate layer may be a glass substrate such as upper substrate layer 406 in FIG. 4, which functions as the interface for touch (e.g., human finger touch). In an embodiment, the light beams are IR beams introduced by one or more light sources, such as light sources 202a-202c and 204a-204c discussed above with respect to FIG. 2.

At step 604, those light beams with glancing angles greater than the critical glancing angle θ_{CG}, as determined by the boundary between the substrate layer and an optically clear adhesive layer, are refracted out of the substrate layer or, in essence, filtered out. In an embodiment, the optically clear adhesive layer has an index of refraction that is greater than that for water but less than that for human skin, such as that from a finger touch. As a result, light beams with a glancing angle less than the critical glancing angle θ_{CG} totally internally reflect at the substrate layer/optically clear adhesive layer interface as well as at the substrate layer/water interface, rendering the touchscreen immune to water interference but still responsive to finger touches.

At step 606, light beams that have not been filtered out of the substrate layer and that have traversed the touch area are detected by one or more detectors at one or more edges of the substrate layer. In an embodiment, the detected light beam signals are passed to a processor specifically assigned to implement touch algorithms, or to a general purpose processor in a greater system, or both.

At step 608, the processor determines whether a touch event occurred, for example based on any measured attenuation in the detected light beam signals.

Process 600 repeats the above steps in a process of detection when a next touch occurs. In this manner, embodiments of the present disclosure represent a water-immune FTIR touchscreen.

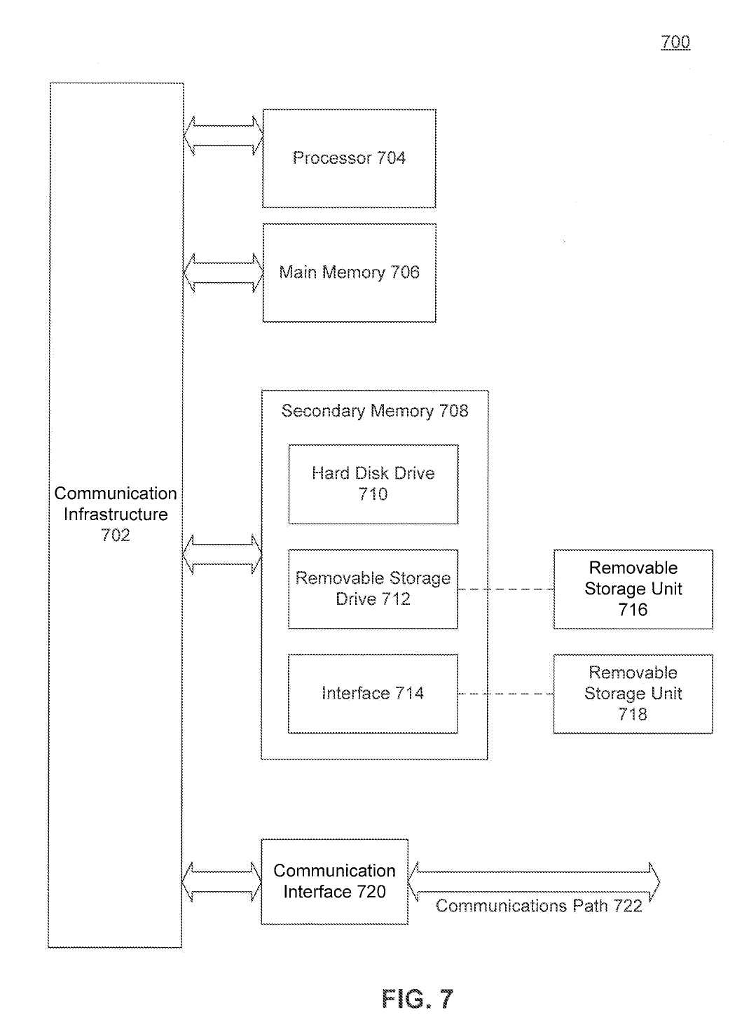

FIG. 7 illustrates an exemplary computer system 700 that can be used to implement aspects of embodiments. Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement aspects of the present disclosure as discussed herein. In particular, the computer programs, when executed, enable processor 704 to implement aspects of the process 600 of the present disclosure. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A water-immune frustrated total internal reflection (FTIR) touchscreen, comprising:
a lower substrate layer comprising a first index of refraction;
an upper substrate layer comprising a second index of refraction and configured to propagate a light beam, the upper substrate layer being situated above the lower substrate layer;
an optically clear adhesive layer comprising a third index of refraction, the optically clear adhesive layer being situated between the lower substrate layer and the upper substrate layer,
wherein the third index of refraction is greater than or approximately equal to an index of refraction for water and less than an index of refraction for human skin.

2. The water-immune FTIR touchscreen of claim 1, further comprising:
a light source configured to emit the light beam, the light source being situated at a first location of an outer edge of a touch area of the water-immune FTIR touchscreen; and
a light detector configured to detect the propagated light beam at a second location of the outer edge of the touch area.

3. The water-immune FTIR touchscreen of claim 2, further comprising:
a processor configured to determine an attenuation in the detected propagated light beam resulting from a touch event in the touch area.

4. The water-immune FTIR touchscreen of claim 1, wherein the lower substrate layer comprises at least a portion of a reflective display.

5. The water-immune FTIR touchscreen of claim 1, wherein:
the light beam comprises an infrared light beam; and
the third index of refraction is greater than or approximately equal to the index of refraction for water and less than the index of refraction for human skin in a wavelength range of the infrared light beam.

6. The water-immune FTIR touchscreen of claim 1, wherein the third index of refraction is less than the first index of refraction.

7. The water-immune FTIR touchscreen of claim 1, wherein:
the first index of refraction is approximately equal to the second index of refraction; and
the third index of refraction is less than the first index of refraction.

8. A method, comprising:
directing, from a light source, a first light beam having a first angle characteristic and a second light beam having a second angle characteristic into an upper substrate layer comprising a first index of refraction, the first angle characteristic being greater than the second angle characteristic;
filtering the first light beam out of the upper substrate layer with an optically clear adhesive layer comprising a second index of refraction, the optically clear adhesive layer being situated below the upper substrate layer, the second index of refraction being greater than or approximately equal to an index of refraction for water and less than an index of refraction for human skin; and
detecting at a light detector the second light beam after propagating through the upper substrate layer.

9. The method of claim 8, further comprising:
directing the second light beam into the upper substrate layer at a specified glancing angle comprising the second angle characteristic, the specified glancing angle being an angle with respect to a plane parallel to a surface of the upper substrate layer that is less than a critical glancing angle for total internal reflection at an interface of the upper substrate layer and the optically clear adhesive layer.

10. The method of claim 8, further comprising:
determining, with a processor, an attenuation in the detected propagated light beam resulting from a touch event in a touch area of a touchscreen comprising the upper substrate layer and the optically clear adhesive layer.

11. The method of claim 8, further comprising:
absorbing the filtered first light beam in a lower substrate layer situated below the optically clear adhesive layer, wherein the lower substrate layer comprises at least a portion of a reflective display.

12. The method of claim 11, wherein the lower substrate layer comprises a third index of refraction, the second index of refraction is less than the third index of refraction, and the first index of refraction is approximately equal to the third index of refraction.

13. A water-immune frustrated total internal reflection (FTIR) touchscreen system, comprising:
a FTIR touchscreen comprising an optically clear adhesive layer situated between lower and upper substrate layers, wherein the upper substrate layer is configured to propagate a light beam, and wherein an index of refraction of the optically clear adhesive layer is greater than or approximately equal to an index of refraction for water and less than an index of refraction for human skin;
a display situated below the FTIR touchscreen; and
a processor configured to determine an attenuation in the detected propagated light beam resulting from a touch event in the touch area.

14. The water-immune FTIR touchscreen system of claim 13, wherein the FTIR touchscreen further comprises:
a light source situated at a first location of an outer edge of a touch area of the FTIR touchscreen and configured to emit the light beam;
a light detector configured to detect the propagated light beam at a second location of the outer edge of the touch area; and
a beam splitter situated near the light source and configured to split the light beam into a first beam and a second beam, the second beam being at an angle to the first beam to enable multitouch detection.

15. The water-immune FTIR touchscreen system of claim 14, wherein the light detector comprises a first light detector configured to detect the first beam at the second location, the second location being situated at a side of the outer edge opposite to the first location, the FTIR touchscreen further comprising:
a second light detector configured to detect the second beam at a third location of the outer edge along an axis perpendicular and adjacent to an axis of the first location.

16. The water-immune FTIR touchscreen system of claim 13, wherein the lower substrate layer comprises at least a portion of a reflective display.

17. The water-immune FTIR touchscreen system of claim 13, wherein:
the light beam comprises an infrared light beam; and
the index of refraction for the optically clear adhesive layer is greater than or approximately equal to the index of refraction for water and less than the index of refraction for human skin in a wavelength range of the infrared light beam.

18. The water-immune FTIR touchscreen system of claim 13, wherein the light beam comprises a glancing angle with respect to a plane parallel to a surface of the upper substrate layer, the glancing angle being less than a critical glancing angle for total internal reflection at an interface of the upper substrate layer and the optically clear adhesive layer.

19. The water-immune FTIR touchscreen system of claim 13, wherein the index of refraction of the optically clear adhesive layer is less than an index of refraction of the upper substrate layer.

20. The water-immune FTIR touchscreen system of claim 13, wherein:
an index of refraction of the upper substrate layer is approximately equal to an index of refraction of the lower substrate layer; and
the index of refraction of the optically clear adhesive layer is less than the index of refraction of the upper substrate layer.
